(19) United States
(12) Patent Application Publication
(10) Pub. No.: US 2003/0021624 A1
(43) Pub. Date: Jan. 30, 2003

(54) Article and method for making a notebook with permanent and disposable elements

(76) Inventor: Cheryl L. Dorsey, Washington, DC (US)

Correspondence Address: LAW OFFICES OF, ROYAL W. CRAIG, A PROFESSIONAL CORPORATION, 10 NORTH CALVERT STREET, SUITE 153, BALTIMORE, MD, 21202, US

(21) Appl. No.: 10/188,286

(22) Filed: Jul. 1, 2002

Related U.S. Application Data
(60) Provisional application No. 60/302,175, filed on Jun. 29, 2001.

(51) Int. Cl. B42F 13/00

(52) U.S. Cl. 402/73

(57) ABSTRACT

A notebook that is convertible into a keepsake compendium after all of the note-taking pages have been filled. The notebook has a front and rear cover bound to a sheaf of individual pages. Each page is pre-printed on a top portion with text or graphic images having a common theme. The bottom portion of each page provides space for note-taking. The top and bottom portions are defined by a perforated line of demarcation which enables the bottom portion of the page to be separated and removed from the notebook after the note-taking portion has been filled. The front and rear covers bear corresponding lines of perforation. Upon removing the bottom portions of the pages and covers, the notebook is converted into a compendium having an inherent keepsake value of its own separate from the notebook.

### CROSS-REFERENCE TO RELATED APPLICATIONS

The present application derives priority from U.S. provisional application No. 60/302,175 for “ARTICLE AND METHOD FOR MAKING A NOTEBOOK WITH PERMANENT AND DISPOSABLE ELEMENTS”; filed Jun. 29, 2001

### BACKGROUND OF THE INVENTION

1. Field of the Invention

The present invention relates to notebooks and, more particularly, to a notebook comprising pages with perforated lines, which is convertible to a keepsake compendium, having inherent value independent of the device as a notebook, after all of the note-taking pages have been filled and removed at the perforations.

2. Description of the Background

Notebooks are well known devices for compiling and maintaining written notes in an organized manner. Notebooks generally comprise a sheaf of paper bound along a top or side margin. Each page is typically a 16-25 lb. paper suitable for marking with pens, pencils, markers, etc. The pages are blank, lined, ruled, or may be lightly colored or contain page numbering. Methods for binding notebooks vary, but well known mechanical methods such as wire-binding, gluing, or stitching are most common. The sheaf is usually protected by a front and back cover, commonly made of a stiffer paper product such as a 10-30 pt. chipboard material. Polypropylene is growing in popularity as a cover material as well.

Perforating the individual pages of a notebook is known in the prior art. Perforations enable a page to be cleanly removed from the notebook, leaving a smooth edge. For example, U.S. Pat. No. 6,146,731 to Tanoto discloses a spiral notepad of individual paper sheets each having a perforated tear line aligned with a spiral binding device. The perforation line comprises micro-perforations and an oval or tear shaped notch adjacent to one end to serve as a tear starter. The perforations are placed close to the margin in Tanoto '731 to maximize note-taking space so that only a small stub remains attached to the notepad after the page has been torn away. Once all of the notebook sheets have been removed, all that remains is the binding means holding the paper stubs, and such binding means and paper stubs are usually discarded.

It would be useful to provide a notebook which continues to serve a useful purpose after all of the note-taking sheets have been filled. The individual pages, including front and back covers, of the notebook are perforated, dividing the pages into a top portion and bottom portion. The top portion is pre-printed with textual or graphic images, and is attached to the binding means. The bottom portion of the page provides space for note-taking, drawing, writing, etc. The individual pages (bottom portions) can be torn and removed at perforations after use, leaving the top portions attached to the binding. The notebook provides an educational tool by addressing a common theme in the pre-printed portion such as motivation, inspiration, history, health education, etc. Thus, once all the pages and front and back cover are removed, the notebook converts into a keepsake compendium of pre-printed material after all of the note-taking pages are removed according to the system of the present invention.

### SUMMARY OF THE INVENTION

It is, therefore, an object of the present invention to provide a notebook which is convertible into a keepsake compendium by tearing off of a bottom portion of each page, the front cover, and the back cover along a perforated line of demarcation.

It is another object of the present invention to provide a notebook having a binding means and having individual pages bearing a line of perforations aligned parallel to the binding means wherein each page is divided into a top and bottom portion.

It is still further an object of the present invention to provide a notebook having a front cover and a rear cover, each cover bearing a line of perforations corresponding to the line of perforations on each individual page.

It is yet another object of the present invention to provide a notebook having the top portion of each page and front and back cover large enough to include pre-printed textual and/or graphic images that support a theme.

It is still yet another object of the present invention to provide a notebook having a keepsake value after all of the note-taking pages have been used, which serves both as an educational compendium and reduces the amount of waste normally generated by discarding used notebooks.

According to the present invention, The notebook comprises a sheaf of individual papers bound along one margin. Each page bears a line of perforations dividing the sheet into two distinct portions. The portion to which the binding means attaches is large enough to be pre-printed with text or graphic material. The text or graphics may collectively be directed to a particular theme such as motivational quotes, statements describing the harmful effects of smoking, historical facts commemorating, for example, black history, etc. The other portion of the page is left blank or lined for note-taking. After the note-taking space has been used, each page is torn off along the line of perforations. The front and back cover likewise bear lines of perforations corresponding to the perforations on each individual page, and such covers are also torn off at the perforations. After all of the pages and covers have been removed at the perforations, the user is left with a compendium of text and graphics related to a common theme which may be saved as a keepsake.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a front perspective view of the notebook of the present invention.

FIG. 2 is a side perspective view of the notebook of the present invention showing the front and rear covers opened.

FIG. 3 is a front perspective view of the keepsake compendium of the present invention after the pages have been separated at the perforations.

### DETAILED DESCRIPTION OF THE PREFERRED EMBODIMENTS

A notebook according to the present invention is shown generally by reference numeral 2 in the drawings.

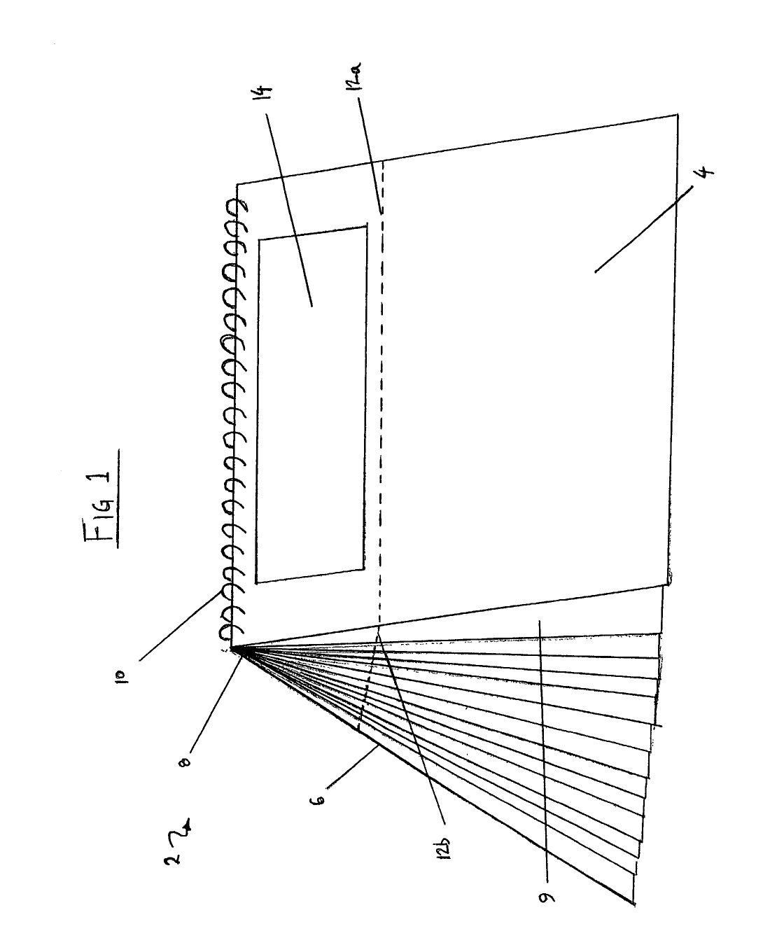

FIG. 1 shows a perspective view of the notebook 2 as it appears in its starting configuration. The notebook 2 comprises a front cover 4, a rear cover 6, and a sheaf 8 of individual pages 9 held there between by a binding means 10. Binding means 10 is preferably a spiral binder, but glue binding, stitching or any other mechanical means known in the art of paper binding may be used. Front cover 4 and rear cover 6 impart a rigidity to the notebook 2. Front cover 4 and rear cover 6 preferably comprise a firm paperstock such as a 10-30 pt. chipboard backing material. The covers may alternatively comprise any materials presently known or used in the manufacture of paper notebook covers including plastics such as polypropylene, or fabric coverings such as denim. Individual pages 9 are preferably a 16-25 lb. paper suitable for writing drawing or note-taking. The pages 9 may be lined or ruled, lightly shaded, pre-numbered or otherwise made suitable as an instrument for note-taking, writing or drawing.

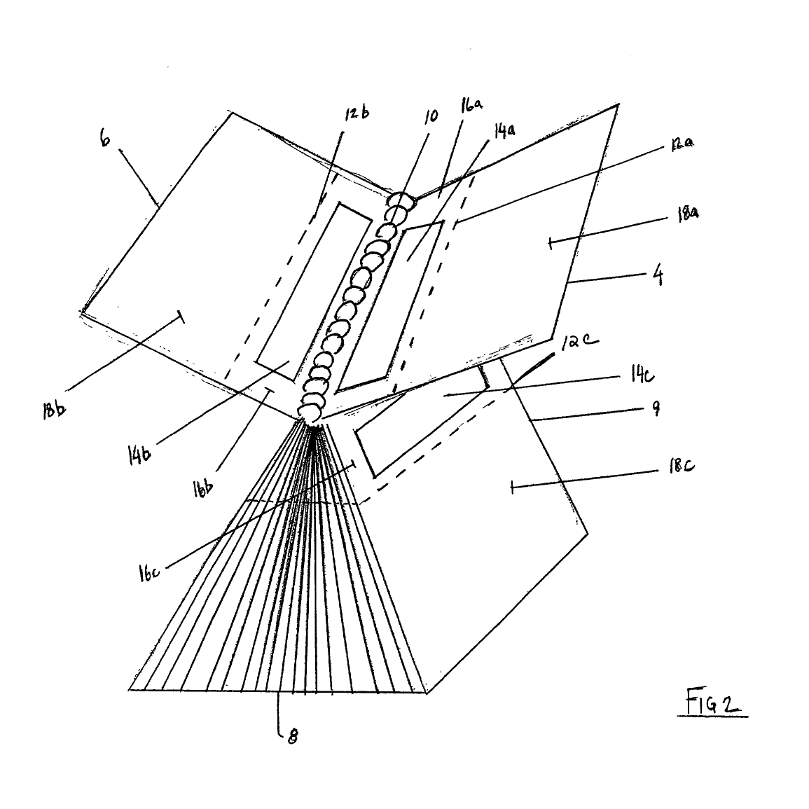

Referring now to FIG. 2, front cover 4, rear cover 6 and individual pages 9 bear a line of perforations 12a, 12b, and 12c respectively. Perforations 12 begin at a side oriented perpendicularly to binding means 10 and extend continuously across the page, running parallel to binding means 10, to the opposing side. Perforations 12 are any method of weakening the page along a line such that the paper can be seamlessly torn away leaving a smooth clean edge.

Perforations 12 divide the pages into top portion 16 (shown in FIG. 2 as 16a, 16b, and 16c corresponding to the front cover, rear cover, and individual pages, respectively) and bottom portion 18 (shown in FIG. 2 as 18a, 18b, and 18c corresponding to the front cover, rear cover, and individual pages, respectively). Top portion 16 is attached to binding means 10. Perforations 12 are spaced a sufficient distance from binding means 10 such that top portion 16 is sufficiently large to visually display printed text or graphics 14. The top portion preferably comprises an area 1″-2″ long and as wide as the sheet of paper. The text or graphics may be printed on front cover 4, rear cover 6, and each individual page 9 as shown in FIG. 2 as 14a, 14b, and 14c respectively. The front and back of each top portion may be printed or alternatively, only one side is printed.

Perforations 12 enable front cover 4, rear cover 6, and individual pages 9 to be torn away from notebook 2 and discarded.

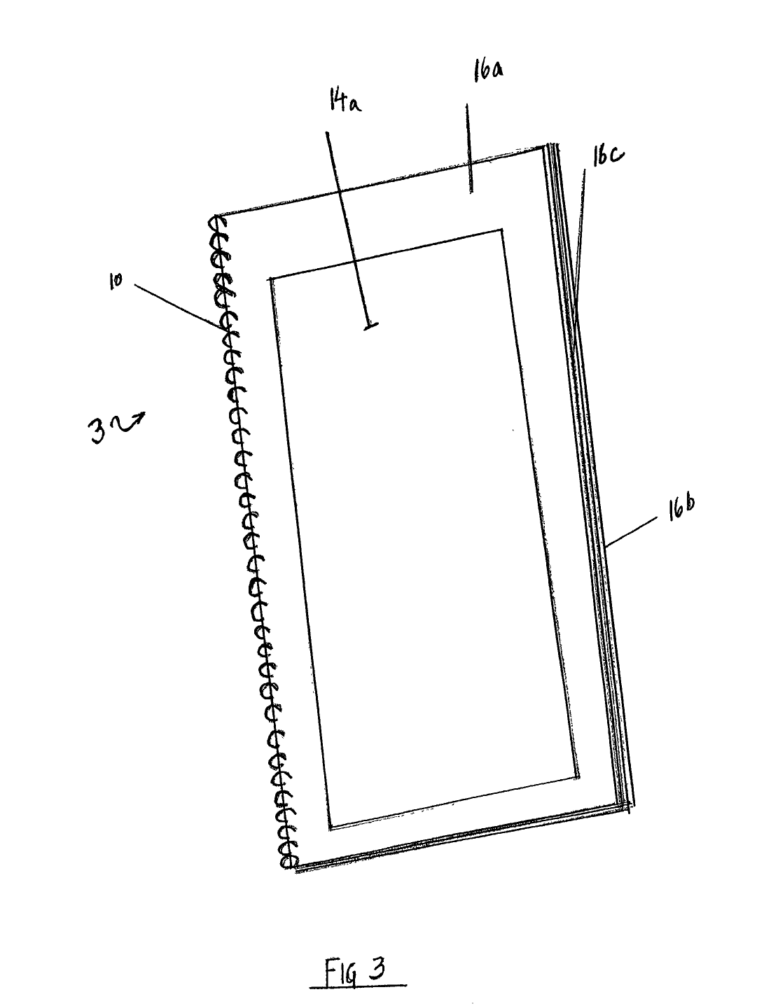

As shown in FIG. 3, separating both covers and each individual page along perforations 12 creates a bound compendium 3 comprising the pre-printed textual or graphic material 14. Compendium 3 is a book comprising top portions 16a, 16b, and 16c of front cover 4, rear cover 6, and individual pages 9 held together by binding means 10. Accordingly, notebook 2 is shown to be convertible into a keepsake compendium 3 having a utility that continues beyond the original note-taking purpose of the notebook. The present invention reduces the waste that is commonly generated from discarded used notebooks.

Text and graphics 14 preferably relate a common positive theme, such as motivational quotes, educational materials related to public health issues, history or the like. The device provides a tool for educating, motivating, or inspiring users. Accordingly, compendium 3 has inherent value and provides the user an incentive to preserve it as a keepsake, rather than to discard it.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims:

I claim:

1. A notebook that is convertible into a keepsake compendium, comprising:
a front cover scored with a line of perforations;
a rear cover scored with a line of perforations;
a sheaf of individual notebook pages each scored with a line of perforations;
a binder for holding together said front cover, rear cover, and said sheaf of individual notebook pages there between;
whereby the lines of perforations on each of said front cover, rear cover and all of said individual notebook pages are aligned parallel to said binder and are uniformly spaced therefrom to divide said front cover, rear cover and individual notebook pages into distinct top portions and bottom portions, and the top portions of said front cover, rear cover and individual notebook pages include printed textual or graphic material.

2. The notebook that is convertible into a keepsake compendium according to claim 1 wherein the top portions of said front cover, rear cover and individual notebook pages all include printed textual or graphic material having a common theme.

3. The notebook that is convertible into a keepsake compendium according to claim 1 wherein the bottom portions of said front cover, rear cover and individual notebook pages all comprise note-taking space.

4. The notebook that is convertible into a keepsake compendium according to claim 3, wherein the bottom portions of said front cover, rear cover and individual notebook pages are adapted for removal at said perforations to leave a keepsake compendium having a common theme.

5. A method for converting a notebook into a keepsake compendium comprising the steps of:
(a) binding a sheaf of individual sheets of paper between a front and rear cover;
(b) dividing said sheets, said front cover and said rear cover into distinct top portions and bottom portions along a perforated line of demarcation;
(c) printing said top portions with text or graphics related to a common theme;
(d) filling said bottom portions with writings and/or drawings by a user;
(e) separating said bottom portions from said top portions along said lines of perforation;
whereby said notebook is converted into a keepsake compendium having an inherent value of its own distinct from said notebook.
